(19) United States
(12) Patent Application Publication
(10) Pub. No.: US 2018/0335823 A1
(43) Pub. Date: Nov. 22, 2018

(54) Method and Apparatus for Reducing Power Consumption of Terminal Device

(71) Applicant: ZTE CORPORATION, Shenzhen City, Guangdong Province (CN)

(72) Inventor: Wei HUANG, Shenzhen (CN)

(21) Appl. No.: 15/578,684

(22) PCT Filed: Jul. 22, 2015
(86) PCT No.: PCT/CN2015/084860

§ 371 Date: Nov. 30, 2017

(30) Foreign Application Priority Data
Jun. 1, 2015 (CN) 201510293882.X

(51) Int. Cl. G06F 1/32

(52) U.S. Cl. CPC G06F 1/3206

(57) ABSTRACT

Disclosed are a method and an apparatus for reducing power consumption of a terminal device. The method includes: monitoring a running state of a current terminal device through a first-type sensor (S102); when the first-type sensor monitors that there is an operation performed on the terminal device, judging whether a parameter value corresponding to the operation monitored by the first-type sensor is greater than or equal to a first preset threshold value according to a first preset detection condition (S104); and when the parameter value is greater than or equal to the first preset threshold value, generating a first trigger instruction for triggering a second-type sensor in the terminal to be enabled (S106), herein power consumption of the first-type sensor is less than power consumption of the second-type sensor.

### TECHNICAL FIELD

The present disclosure relates to the field of communication, in particular to a method and an apparatus for reducing power consumption of a terminal device.

### BACKGROUND

With the progress of science and technology, motion sensing technology used in a terminal device starts to develop rapidly. In commonly-used terminal devices, intelligent motion sensing technology can judge an environment in which a user is located and an action of the user through sensors, prejudge an operation wanted by the user and intelligently and automatically execute the operation, such that the using efficiency can be improved and the product competitiveness is enhanced. Herein, the terminal devices at least may include smart phones, tablet computers, intelligent motion sensing devices, palm computers and the like.

In a use process of existing terminal devices, in order to satisfy the demands for prejudging and realizing a current scenario and a function to be operated by a user, a terminal device often needs one or multiple sensors to cooperatively work for realization. Therefore, a power endurance time of a terminal device is greatly shortened due to high power consumption of multiple sensors. In addition, with the continuous emergence of new sensors, in order to cooperatively work to satisfy operation functions needed by a current scenario or user, inevitably internal system power consumption of a terminal device is caused to increase since more and more sensors are used, and the power endurance time of a terminal device is further reduced.

Aiming at the problem that the power endurance time of a terminal device is reduced due to system power consumption increase caused by the cooperative working of multiple sensors, no effective solution has already been provided up to now.

### SUMMARY

Embodiments of the present disclosure provide a method and an apparatus for reducing power consumption of a terminal device, so as to at least solve the problem that power endurance time of a terminal device is reduced due to system power consumption increase caused by the cooperative working of multiple sensors in the related art.

According to an embodiment of the present disclosure, the present disclosure provides a method for reducing power consumption of a terminal device, including: monitoring a running state of a current terminal device through a first-type sensor; when the first-type sensor monitors that there is an operation performed on the terminal device, judging whether a parameter value corresponding to the operation monitored by the first-type sensor is greater than or equal to a first preset threshold value according to a first preset detection condition; and when the parameter value is greater than or equal to the first preset threshold value, generating a first trigger instruction for triggering a second-type sensor in the terminal to be enabled, herein power consumption of the first-type sensor is less than the power consumption of the second-type sensor.

In an embodiment of the present disclosure, after the step of generating the first trigger instruction for triggering the second-type sensor in the terminal to be enabled, the method further includes: enabling the second-type sensor according to the first trigger instruction and detecting whether a parameter value acquired by the second-type sensor is greater than or equal to a second preset threshold value according to a second preset detection condition; when the parameter value is greater than or equal to the second preset threshold value, generating a second trigger instruction for triggering an operation program corresponding to the operation; and executing the operation program corresponding to the second trigger instruction in response to the second trigger instruction.

In an embodiment of the present disclosure, the method further includes: when the parameter value is less than the first preset threshold value, performing detection on the operation for a second time according to the first preset detection condition and judging whether the parameter value corresponding to the operation is greater than or equal to the first preset threshold value; and if the parameter value is less than the first preset threshold value in the detection of the second time according to the first preset detection condition, detecting the parameter value corresponding to the operation again according to the first preset detection condition till the parameter value corresponding to the operation is greater than or equal to the first preset threshold value.

In an embodiment of the present disclosure, the method further includes: when the parameter value is less than the second preset threshold value, performing detection on the operation for a second time according to the second preset detection condition and judging whether the parameter value corresponding to the operation is greater than or equal to the second preset threshold value; and if the parameter value is less than the second preset threshold value in the detection of the second time according to the second preset detection condition, detecting the parameter value corresponding to the operation again according to the second preset detection condition till the parameter value corresponding to the operation is greater than or equal to the second preset threshold value.

In an embodiment of the present disclosure, the second preset detection condition is used for detecting whether the operation triggers the corresponding operation program; and/or the second preset threshold value is a threshold value determined according to an upper limit of the power consumption of the second-type sensor.

In an embodiment of the present disclosure, after the step of executing the operation program corresponding to the second trigger instruction in response to the second trigger instruction, the method further includes: returning an operation state of monitoring the running state of the current terminal device through the first-type sensor.

In an embodiment of the present disclosure, the first preset detection condition is used for detecting whether the operation triggers the second-type sensor; and/or the first preset threshold value is a threshold value determined according to an upper limit of the power consumption of the first-type sensor.

In an embodiment of the present disclosure, the second preset detection condition is used for detecting whether the operation triggers the corresponding operation program; and/or the second preset threshold value is a threshold value determined according to an upper limit of the power consumption of the second-type sensor.

In an embodiment of the present disclosure, before the step of monitoring the running state of the current terminal device through the first-type sensor, the method further includes: displaying a setting interface; acquiring a motion sensing parameter edited by a user according to a preset page guide on the setting interface; acquiring a corresponding relation between the motion sensing parameter and the first preset detection condition and the second preset detection condition, and generating a corresponding relation list; and storing the corresponding relation list.

According to another embodiment of the present disclosure, an apparatus for reducing power consumption of a terminal device is provided, including: a monitoring module configured to monitor a running state of a current terminal device through a first-type sensor; a first detection module configured to, when the first-type sensor monitors that there is an operation performed on the terminal device, judge whether a parameter value corresponding to the operation monitored by the first-type sensor is greater than or equal to a first preset threshold value according to a first preset detection condition; and a first instruction generation module configured to, when the parameter value is greater than or equal to the first preset threshold value, generate a first trigger instruction for triggering a second-type sensor in the terminal to be enabled, herein the power consumption of the first-type sensor is less than the power consumption of the second-type sensor.

In an embodiment of the present disclosure, the apparatus further includes: a second detection module configured to, after the first trigger instruction for triggering the second-type sensor in the terminal to be enabled is generated, enable the second-type sensor according to the first trigger instruction and detect whether a parameter value acquired by the second-type sensor is greater than or equal to a second preset threshold value according to a second preset detection condition; a second instruction generation module configured to, when the parameter value is greater than or equal to the second preset threshold value, generate a second trigger instruction for triggering an operation program corresponding to the operation; and a response module configured to execute the operation program corresponding to the second trigger instruction in response to the second trigger instruction.

In an embodiment of the present disclosure, the apparatus further includes: a third detection module configured to, when the parameter value is less than the first preset threshold value, perform detection on the operation for a second time according to the first preset detection condition and judge whether the parameter value corresponding to the operation is greater than or equal to the first preset threshold value; and a fourth detection module configured to, when the parameter value is less than the first preset threshold value in the detection of the second time according to the first preset detection condition, detect the parameter value corresponding to the operation again according to the first preset detection condition till the parameter value corresponding to the operation is greater than or equal to the first preset threshold value.

In an embodiment of the present disclosure, the apparatus further includes: a fifth detection module configured to, when the parameter value is less than the second preset threshold value, perform detection on the operation for a second time according to the second preset detection condition and judge whether the parameter value corresponding to the operation is greater than or equal to the second preset threshold value; and a sixth detection module configured to, when the parameter value is less than the second preset threshold value in the detection of the second time according to the second preset detection condition, detect the parameter value corresponding to the operation again according to the second preset detection condition till the parameter value corresponding to the operation is greater than or equal to the second preset threshold value.

In an embodiment of the present disclosure, the apparatus further includes: a returning module configured to, after the operation program corresponding to the second trigger instruction is executed in response to the second trigger instruction, return an operation state of monitoring the running state of the current terminal device through the first-type sensor.

In an embodiment of the present disclosure, the apparatus further includes: a display module configured to, before the running state of the current terminal device is monitored through the first-type sensor, display a setting interface; an acquisition module configured to acquire a motion sensing parameter edited by a user according to a preset page guide on the setting interface; a list generation module configured to acquire a corresponding relation between the motion sensing parameter and the first preset detection condition and the second preset detection condition, and generate a corresponding relation list; and a storage module configured to store the corresponding relation list.

In the embodiments of the present disclosure, a running state of a current terminal device is monitored through a first-type sensor; when the first-type sensor monitors that an operation performed on the terminal device exists, it is judged whether a parameter value corresponding to the operation monitored by the first-type sensor is greater than or equal to a first preset threshold value according to a first preset detection condition. When the parameter value is greater than or equal to the first preset threshold value, a first trigger instruction for triggering a second-type sensor in the terminal to be enabled is generated, herein the power consumption of the first-type sensor is less than the power consumption of the second-type sensor. The problem that power endurance time of the terminal device is reduced due to system power consumption increase caused by the cooperative working of multiple sensors in the related art, is solved, thus gradually enabling sensors with different types of power consumption according to the actual operation, reducing the system power consumption of the terminal device and improving the power endurance time of the terminal device.

### BRIEF DESCRIPTION OF DRAWINGS

The drawings described here are used for providing further understanding about the present disclosure, and constitute a part of the present application. The exemplary embodiments of the present disclosure and the description thereof are used for explaining the present disclosure instead of improperly limiting the present disclosure. In the drawings:

FIG. 1 illustrates a flowchart of a method for reducing power consumption of a terminal device according to an embodiment of the present disclosure.

FIG. 2 illustrates a flowchart of a setting process in the method for reducing power consumption of a terminal device according to an embodiment of the present disclosure.

FIG. 3 illustrates a flowchart of a method for reducing power consumption of a terminal device according to an embodiment of the present disclosure.

FIG. 4 illustrates a structural diagram of an apparatus for reducing power consumption of a terminal device according to an embodiment of the present disclosure.

FIG. 5 illustrates a structural diagram of an apparatus for reducing power consumption of a terminal device according to an embodiment of the present disclosure.

FIG. 6 illustrates a structural diagram of another apparatus for reducing power consumption of a terminal device according to an embodiment of the present disclosure.

FIG. 7 illustrates a structural diagram of still another apparatus for reducing power consumption of a terminal device according to the embodiment of the present disclosure.

FIG. 8 illustrates a structural diagram of further another apparatus for reducing power consumption of a terminal device according to the embodiment of the present disclosure.

FIG. 9 illustrates a structural diagram of an apparatus for reducing power consumption of a terminal device according to another embodiment of the present disclosure.

### DETAILED DESCRIPTION

The present disclosure will be described below in detail with reference to the drawings in combination with embodiments. It needs to be stated that embodiments in the present application and features in the embodiments may be mutually combined under a situation of no conflict.

It needs to be stated that terms such as “first” and “second” in the specification, the claims and the drawings of the present disclosure are used for distinguishing similar objects instead of necessarily describing specific orders or sequences.

### Embodiment 1

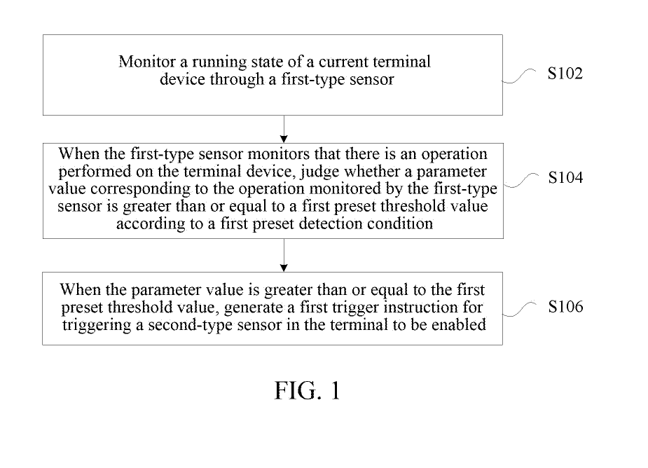

This embodiment provides a method for reducing power consumption of a terminal device. FIG. 1 is a flowchart of a method for reducing power consumption of a terminal device according to an embodiment of the present disclosure. As illustrated in FIG. 1, the flow includes the following steps.

In step S102, a running state of a current terminal device is monitored through a first-type sensor.

The method for reducing power consumption of a terminal device provided by the embodiment of the present application is applicable to a terminal device, the first-type sensor is set in a monitoring state when initially working, i.e., monitoring whether there is any operation performed on the current terminal device, and when any operation exists, step S104 is triggered.

Herein, the terminal device may at least include one or a combination of at least two of smart phone, notebook computer, tablet computer, palm computer, MPEG Audio Layer 3 (mp3) media player, MPEG Audio Layer 4 (mp4) media player, portable intelligent wearable device.

In step S104, when the first-type sensor monitors that there is an operation performed on the terminal device, whether a parameter value corresponding to the operation monitored by the first-type sensor is greater than or equal to a first preset threshold value is judged according to a first preset detection condition.

Specifically, the terminal device in the embodiment of the present application may at least include a first-type sensor and a second-type sensor, the first-type sensor and the second-type sensor are classified based on power consumption, from high to low, of a system in the entire terminal device, e.g., by taking 2 mA as a threshold value, a sensor with power consumption less than 2 mA is classified as the first-type sensor (i.e., low-power-consumption sensor) and a sensor with power consumption greater than or equal to 2 mA is classified as the second-type sensor (i.e., high-power-consumption sensor).

Herein, the first-type sensor may be a low-power-consumption sensor applicable to the first preset detection condition, for example, the first preset threshold value of the first preset detection condition may be 2 mA, and the low-power-consumption sensor may at least include: acceleration sensor, proximity sensor, light sensor, etc., i.e., whether a power consumption parameter of the first-type sensor triggered by an operation is greater than or equal to the first preset threshold value is detected according to the first preset detection condition.

Specifically, for example, supposing that the terminal device is a smart phone referred as mobile phone below, the first-type sensor is one or a combination of at least two of an acceleration sensor, a proximity sensor or a light sensor, the first preset threshold value is 2 mA for example, and the operation is taking the smart phone out of a pocket of clothes or a bag (i.e., an action of moving from a dark place to a bright place). When the mobile phone moves from the dark place to the bright place, the light sensor is triggered by a change of brightness of received light, the acceleration sensor is triggered by a change of shake of the mobile phone, and whether a sum of power consumption values of the light sensor and the acceleration sensor is greater than or equal to 2 mA when the mobile phone is moved from the dark place to the bright place is detected according to the first preset detection condition. For example, if the power consumption value of the light sensor is W1 and the power consumption value of the acceleration sensor is W2, when it is detected that the mobile phone is moved from the dark place to the bright place according to the first preset detection condition, whether a sum of W1 and W2 is greater than or equal to 2 mA is judged. In this embodiment, the first preset detection condition may be an algorithm used for detecting the power consumption of the first-type sensor, i.e., by accumulating the power consumption values of all first-type sensors. If the accumulated power consumption value is greater than the first preset threshold value, it indicates that the operation acquired by the first-type sensor currently needs to be further confirmed by a second-type sensor, and step S106 is performed.

In step S106, when the parameter value is greater than or equal to the first preset threshold value, a first trigger instruction for triggering a second-type sensor in the terminal to be enabled is generated, herein the power consumption of the first-type sensor is less than the power consumption of the second-type sensor.

Herein, based on step S104, here the second-type sensor is different from the first-type sensor in that it is a high-power-consumption sensor with its power consumption greater than the power consumption of the first-type sensor. In an embodiment of the present application, the high-power-consumption sensor at least includes: a geomagnetic sensor and/or a gyroscope sensor, etc.

To sum up, still based on the example in step S104, if the power consumption of the light sensor and the acceleration sensor triggered by the action that the mobile phone is moved from the dark place to the bright place is greater than or equal to 2 mA, the first trigger instruction is generated and the first trigger instruction is used for triggering the second-type sensor, i.e., the geomagnetic sensor and/or the gyroscope sensor.

Through the above-mentioned steps, the running state of the current terminal device is monitored through the first-type sensor; when the operation performed on the terminal device is acquired by the first-type sensor, whether the parameter value corresponding to the operation acquired by the first-type sensor in the terminal device is greater than or equal to the first preset threshold value is judged according to the first preset detection condition; and when the parameter value is greater than or equal to the first preset threshold value, the first trigger instruction for triggering the second-type sensor in the terminal to be enabled is generated, herein the power consumption of the first-type sensor is less than the power consumption of the second-type sensor. The problem that power endurance time of the terminal device is reduced due to system power consumption increase caused by the cooperative working of multiple sensors is solved, thus gradually enabling sensors with different types of power consumption according to the actual operation, reducing the power consumption of the terminal device and improving the power endurance time of the terminal device.

To sum up, in combination with step S102 to step S106, supposing that, for example, the operation performed by the user and detected by the mobile phone is movement of the mobile phone from the dark place to the bright place, the first-type sensor is the light sensor and the acceleration sensor and the second-type sensor is the gyroscope sensor, and supposing that an operation program corresponding to the operation is a photographing program, the method for reducing the power consumption of the terminal device provided by the embodiment of the present application may specifically include the following steps.

Firstly, detection is performed by taking the first preset detection condition (i.e., detection performed on the first-type sensor) as an initial default detection condition. When the light sensor acquires that the parameter of the mobile phone at the dark place changes to the parameter of the mobile phone at the bright place, i.e., a light value acquired by a light sensing component in the light sensor gradually increases; and when the movement of the mobile phone from the dark place to the bright place triggers the acceleration sensor to acquire that the mobile phone shakes and if the shaking speed changes from an initial value to a value greater than the preset value, in combination with the power consumption value corresponding to the operation of the light sensor and the acceleration sensor, i.e., the parameter values whether the parameter value is greater than or equal to the first preset threshold value is judged.

Secondly, when the parameter value is greater than or equal to the first preset threshold value, obviously the operation performed by the current user cannot be satisfied in the first-type sensor. Therefore, the second-type sensor is further triggered and whether the parameter value is greater than or equal to a second preset threshold value is judged according to a second preset detection condition. Supposing that the operation performed by the current user triggers the gyroscope sensor, i.e., the operation is actually a posed photographing action, whether the parameter value is greater than or equal to the second preset threshold value is judged.

Finally, when the parameter value is greater than or equal to the second preset threshold value, according to a preset corresponding relation between the operation and the corresponding operation program, the photographing program is triggered to photograph.

In the embodiment of the present disclosure, in step S106, after the first trigger instruction for triggering the second-type sensor in the terminal to be enabled is generated, the method for reducing the power consumption of the terminal device provided by the embodiment of the present application further includes the following steps.

In step S108, the second-type sensor is enabled according to the first trigger instruction and whether the parameter value acquired by the second-type sensor is greater than or equal to a second preset threshold value is detected according to a second preset detection condition.

Herein, the second-type sensor is enabled based on the first trigger instruction generated in step S106, the parameter value corresponding to the operation is further judged according to the second preset detection condition and whether the parameter of the second-type sensor triggered by the operation is greater than or equal to the second preset threshold value is detected.

Supposing that the second preset threshold value is 4 mA, the second-type sensor is the geomagnetic sensor and/or the gyroscope sensor, when the geomagnetic sensor and/or the gyroscope sensor is enabled according to the first trigger sensor, whether the parameter value corresponding to the operation when the mobile phone is moved from the dark place to the bright place is greater than or equal to 4 mA is judged according to the second preset detection condition.

In this embodiment, the second preset detection condition may be an algorithm used for detecting the power consumption of the second-type sensor, i.e., by accumulating the power consumption values of all second-type sensors, if the accumulated power consumption value is greater than the second preset threshold value, it indicates that the operation acquired by the second-type sensor currently will trigger the corresponding operation program, and step S110 is performed. In this embodiment, if the geomagnetic sensor and the gyroscope sensor are enabled, when the power consumption value is calculated, the power consumption values of the geomagnetic sensor and the gyroscope sensor are accumulated to obtain an accumulated sum, whether the accumulated sum exceeds the second preset threshold value is judged, and if the accumulated sum is greater than or equal to the second preset threshold value, step S110 is executed.

In step S110, when the parameter value is greater than or equal to the second preset threshold value, a second trigger instruction for triggering an operation program corresponding to the operation is generated.

Here still based on the example in step S108, after the second-type sensor (i.e., the high-power-consumption sensor) is enabled, when the parameter value corresponding to the action of moving the mobile phone from the dark place to the bright place is greater than or equal to the second preset threshold value, the second trigger instruction for triggering the operation program corresponding to the action of moving the mobile phone from the dark place to the bright place is generated.

For example, when the mobile phone is moved from the dark place to the bright place, supposing that the action may be that the user moves the mobile phone in front of the face to prepare for enabling a photographing function, when the parameter value, corresponding to the action, of the high-power-consumption sensor in the mobile phone is obtained according to the second preset detection condition and the parameter value is greater than or equal to the second preset threshold value, the second trigger instruction for triggering the photographing function is generated.

In step S112, the operation program corresponding to the second trigger instruction is executed in response to the second trigger instruction.

Herein, based on step S102 to step S106, still by taking that the action of moving the mobile phone from the dark place to the bright place is a photographing action as an example, after the second trigger instruction is generated, the photographing function of the mobile phone is enabled.

In the embodiment of the present disclosure, different from step S104, the method for reducing the power consumption of the terminal device provided by the embodiment of the present application further includes the following steps.

In step S105, when the parameter value is less than the first preset threshold value, detection is performed on the operation for a second time according to the first preset detection condition and whether the parameter value corresponding to the operation is greater than or equal to the first preset threshold value is judged.

Herein, still by taking the example in step S104 as an example, when the power consumption value (i.e., parameter value) of the first-type sensor triggered by the operation of moving the mobile phone from the dark place to the bright place is less than 2 mA (the first preset threshold value), the second time of detection is performed on the operation according to the first preset detection condition, whether the power consumption value of the first-type sensor triggered by the operation is greater than or equal to 2 mA is judged, i.e., whether the operation has other action features to make the power consumption value of the triggered first-type sensor change.

In step S107, if the parameter value is less than the first preset threshold value in the second time of detection according to the first preset detection condition, the parameter value corresponding to the operation is detected again according to the first preset detection condition till the parameter value corresponding to the operation is greater than or equal to the first preset threshold value.

Herein, the parameter value in the detection of the second time according to the first preset detection condition is judged for the second time, and if the parameter value is still less than the first preset threshold value, detection is performed for the third time according to the first preset detection condition till the parameter value corresponding to the operation is greater than or equal to the first preset threshold value.

In the embodiment of the present disclosure, different from step S110, the method for reducing the power consumption of the terminal device provided by the embodiment of the present application further includes the following steps.

In step S111, when the parameter value is less than the second preset threshold value, detection is performed on the operation for the second time according to the second preset detection condition and whether the parameter value corresponding to the operation is greater than or equal to the second preset threshold value is judged.

Herein, still by taking the example in step S108 as an example, when the power consumption value (i.e., second parameter value) of the second-type sensor triggered by the operation of moving the mobile phone from the dark place to the bright place is less than 4 mA (the second preset threshold value), detection is performed on the operation for the second time according to the second preset detection condition, whether the power consumption value of the second-type sensor triggered by the operation is greater than or equal to 4 mA is judged, i.e., whether the operation has other action features to make the power consumption value of the triggered second-type sensor change.

In step S113, if the parameter value is less than the second preset threshold value in the second time of detection according to the second preset detection condition, the parameter value corresponding to the operation is detected again according to the second preset detection condition till the parameter value corresponding to the operation is greater than or equal to the second preset threshold value.

Herein, the parameter value in the detection of the second time according to the second preset detection condition is judged for the second time, and if the parameter value is still less than the second preset threshold value, detection is performed for the third time according to the second preset detection condition till the parameter value corresponding to the operation is greater than or equal to the second preset threshold value.

Here, the embodiment of the present application provides a default mechanism. In order to reduce the system power consumption of the terminal device, before the operation program corresponding to the operation performed by the user is enabled, detection is performed by taking the first preset detection condition as the initial detection condition, i.e., the low-power-consumption sensor is used for detecting the behavior of the user; when the detected parameter corresponding to the operation performed by the user is greater than or equal to the first preset threshold value, the high-power-consumption sensor is enabled, and detection is performed on the operation according to the second preset detection condition after the high-power-consumption sensor is enabled; and if the parameter corresponding to the operation is greater than the second preset threshold value, the operation program corresponding to the operation is enabled.

In the embodiment of the present application, by detecting periodically to enable sensors with different power consumption levels periodically and further detecting the behavior of the user step by step, the terminal device can always run at low power consumption, thus the system power consumption of the terminal device is reduced and the power endurance time of terminal device is guaranteed to be prolonged.

Besides, the embodiment of the present application is described by taking that the first preset threshold value is 2 mA and the second preset threshold value is 4 mA as an example, is subject to the method for reducing the power consumption of the terminal device provided by the embodiment of the present application, and is not specifically limited.

In the embodiment of the present disclosure, after step S112, i.e., after the operation program corresponding to the second trigger instruction is executed in response to the second trigger instruction, the method for reducing the power consumption of the terminal device provided by the embodiment of the present application further includes the following step.

In step S115, after the operation program is completely executed, an operation state of detecting whether the parameter value corresponding to the operation acquired by the first-type sensor in the terminal is greater than or equal to the first preset threshold value according to the first preset detection condition, is returned.

Specifically, based on step S102 to step S106, after the operation program corresponding to the operation is completely executed, the terminal returns an operation state of detecting whether the parameter value corresponding to the operation acquired by the first-type sensor in the terminal is greater than or equal to the first preset threshold value according to the first preset detection condition. Accordingly, it can be seen that, after the terminal completely executes the operation program corresponding to the operation, the terminal detects the first-type sensor by using the first preset detection condition for detecting the power consumption of the first-type sensor as an initial condition, so as to guarantee that the system power consumption in the terminal is always kept to be the lowest.

In the embodiment of the present disclosure, the first preset detection condition is used for detecting whether the operation triggers the second-type sensor; and/or the first preset threshold value is a threshold value determined according to an upper limit of the power consumption of the first-type sensor.

In the embodiment of the present disclosure, the second preset detection condition is used for detecting whether the operation triggers the corresponding operation program; and/or the second preset threshold value is a threshold value determined according to an upper limit of the power consumption of the second-type sensor.

Preferably, in the method provided by the embodiment of the present application, before step S102, i.e., the running state of the current terminal device is monitored through the first-type sensor, the method further includes the following steps.

In step S98, a setting interface is displayed.

In step S99, a motion sensing parameter edited by a user is acquired according to a preset page guide on the setting interface.

In step S100, a corresponding relation between the motion sensing parameter and the first preset detection condition and the second preset detection condition is acquired, and a corresponding relation list is generated.

In step S101, the corresponding relation list is stored.

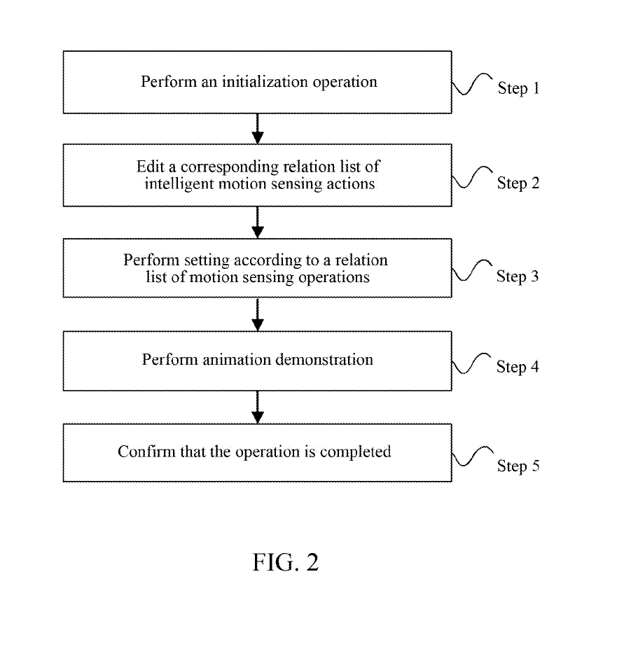

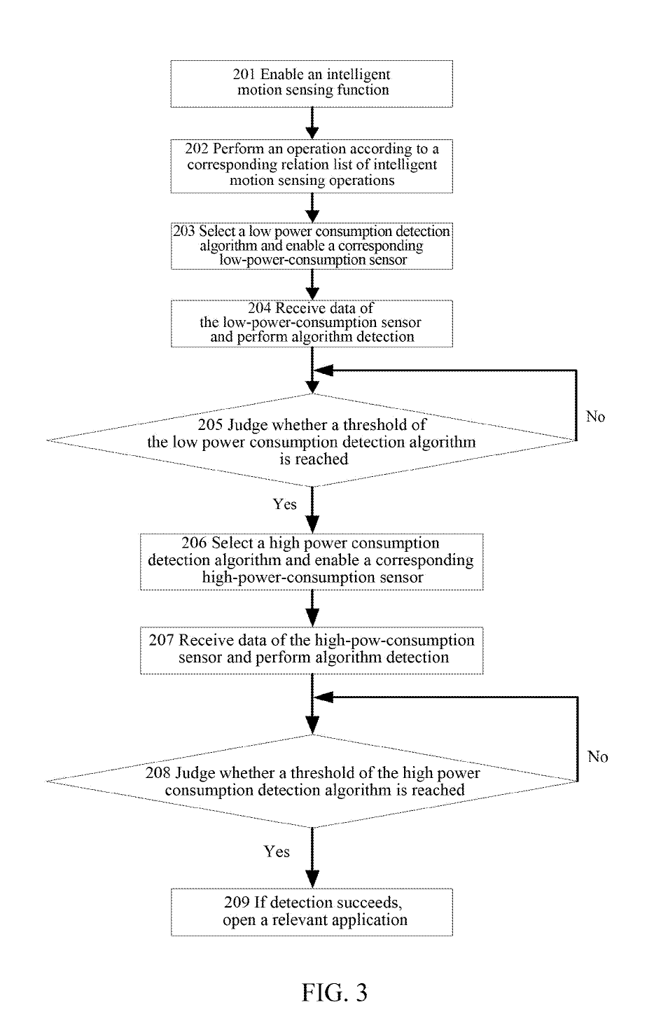

In combination with step S98 to step S101, which are a process for setting the corresponding relation between the operation action of the user and the first preset detection condition and the second preset detection condition provided by the embodiment of the present application, based on the setting process, the operation action of the user is judged further according to the corresponding relation in step S102 to step S106, which is specifically as follows. FIG. 2 illustrates a flowchart of a setting process in a method for reducing power consumption of a terminal device according to the embodiment of the present disclosure. As illustrated in FIG. 2, in step 1, an intelligent motion sensing setting module of a terminal is enabled and a system performs an initialization operation. In step 2, a corresponding relation list of motion sensing actions is edited to correlate and match a low power consumption detection algorithm to a high power consumption detection algorithm. In step 3, setting is performed according to a relation list of motion sensing operations, and relevant sensors and algorithms are enabled according to the corresponding relation list of motion sensing actions. In step 4, animation demonstration is performed corresponding to the relation list of motion sensing operations to make a user further understand relations between motion sensing operations. In step 5, the user is guided to know intelligent motion sensing operations and “OK” is clicked to complete the operation. Supposing that the terminal device is a smart phone for example, the mobile phone displays the setting interface and guides the user to enable the intelligent motion sensing setting of the terminal through the preset page guide on the setting interface, and the system performs the initialization operation. By editing the corresponding relation list of motion sensing actions, the low power consumption detection algorithm and the high power consumption algorithm are correlated to and matched with the operation actions of the user. The system performs setting according to the relation list of motion sensing operations and enables the corresponding sensors and algorithms according to the corresponding relation list of motion sensing actions. After the setting is completed, the relation between the motion sensing operations and the low power consumption detection algorithm and the high power consumption detection algorithm is further presented to the user through animation demonstration. In the embodiment of the present disclosure, a confirmation interface is displayed to guide the user to click “OK” to complete the operation. Specifically, based on the embodiments corresponding to FIG. 1 and FIG. 2, FIG. 3 illustrates a flowchart of a method for reducing power consumption of a terminal device according to the embodiment of the present disclosure. As illustrated in FIG. 3, the method for reducing the power consumption of the terminal device is described through specific examples in the embodiment of the present application, herein, by taking “a user uses a motion sensing camera function” as an example, a process for implementing the method for reducing the power consumption of the terminal device provided by the embodiment of the present application includes the following steps.

In step 201, an intelligent motion sensing function is enabled to query a user setting.

In step 202, an operation is performed according to a corresponding relation list of intelligent motion sensing operations to enable a relevant sensor.

In step 203, a low power consumption detection algorithm is preferentially selected and a corresponding low-power-consumption sensor is enabled.

In step 204, data of the low-power-consumption sensor are received and detection is performed by using the low power consumption detection algorithm.

In step 205, for an action performed by a user, it is judged whether a threshold of the low power consumption detection algorithm is reached, if the threshold is reached, step 206 is executed; and if the threshold is not reached, the process returns to step 204 for continuous detection.

In step 206, the threshold of the low power consumption detection algorithm is satisfied, a high-power-consumption sensor is enabled and a high power consumption detection algorithm is selected for precisely judging the action.

In step 207, data of the high-power-consumption sensor are received and algorithm detection is performed.

In step 208, whether a threshold of the high power consumption detection algorithm is reached is judged, if the threshold is reached, step 209 is executed; and if the threshold is not reached, the process returns to step 207 for continuous detection.

In step 209, if detection succeeds, the action of the user is judged according to motion sensing detection to predict an intention of the user and a corresponding relevant application is opened.

Specifically, after the user starts the system, the system performs initialization and the initialization includes establishment of the corresponding relation list. The user may edit the corresponding relation list, the user selects the high power consumption motion sensing algorithm “Motion sensing camera” to be correlated to the low power consumption motion sensing algorithm “Static mode”, after “OK” is clicked, the corresponding relation is set. The low power consumption algorithm “Static mode” is used to execute detection when the user lays the mobile phone flat, the threshold of exiting “Static mode” is satisfied when the user takes up the mobile phone, the high power consumption motion sensing algorithm “Motion sensing camera” is used to execute detection, and the relevant application is run to satisfy the need of the user after detection succeeds.

The embodiment of the present application provides an intelligent terminal motion sensing power consumption optimization solution which is simple and feasible, allows users to autonomously set and achieves better user experience, and these advantages are not possessed in the current intelligent motion sensing field. In the embodiment of the present application, by dividing the power consumption of sensors used by the intelligent terminal, the low power consumption algorithm is completed by using low-power-consumption sensors and a basic posture of the user is judged, on the premise that the basic posture of the user is satisfied, the needed sensors are all enabled to make an accurate judgment through the high power consumption algorithm, and thus the system power consumption is reduced, the endurance time is increased and the user experience are greatly improved. Herein, intelligent motion sensing refers to judging an environment in which a user is located and an action of the user through sensors, prejudging an operation wanted by the user and intelligently and automatically executing the operation, such that the user satisfaction is improved.

Herein, in the embodiment of the present application, intelligent motion sensing recognition is usually completed through combination judgment of sensors, working current for sensor measurement is measured. Sensors with power consumption greater than 2 mA are set aside as high-power-consumption sensors, such as geomagnetic sensors and gyroscope sensors. Sensors with power consumption less than or equal to 2 mA are set aside as low-power-consumption sensors, such as acceleration sensors, proximity sensors and light sensors. The low-power-consumption sensors are combined to judge the basic posture of the user, e.g., whether the mobile phone is put in a pocket, whether the mobile phone is flatly placed on a desktop, whether the user takes up the mobile phone, etc., so as to complete the judgment by using the low power consumption algorithm. Precise recognition of user postures, such as whether the intelligent terminal is close to the ear, whether a specific trajectory is made in air and whether a specific action is made, requires more sensors as possible for judgment, and the high power consumption algorithm is used to complete precise judgment for user state and action.

In the embodiment of the present disclosure, state machines are established to manage the relation between user states and intelligent motion sensing detection. The state machines are divided into a state machine for user basic posture judgment and a state machine for user action precise recognition, which respectively manage corresponding relations between detection data and recognition results under situations of basic posture and precise action recognition. This process includes two small steps, i.e., step 1, states are divided and different algorithms are selected; and step 2, in which corresponding relations between states and algorithms are established.

1. States are divided. This item is an intermediate condition for detection data to initiate recognition results. States to be divided include two types, i.e., a basic state and a user action state. After basic state recognition, user action state recognition is performed. After user action state recognition, the process returns to basic state recognition.

Basic states are common mobile phone states. Common mobile phone states may be divided into a static mode, an incoming call mode, a pocket mode, etc. States may be established according to some common conditions such as using an acceleration sensor (low-power-consumption sensor), whether a user has laid an intelligent terminal flatly and statically is judged according to a low power consumption algorithm. If the intelligent terminal is in a static flatly-laid state, the user is not in other motion sensing action states at the same time, and thereby no high-power-consumption sensor is enabled to judge a user action.

A user action state refers to a state in which a user is very possibly performing a motion sensing operation with a basic state having been changed, and thus more sensors such as a gyroscope (high-power-consumption sensor) are enabled as possible to judge a user action and prejudge a user intention. For example, in case of not being in a static state, sensors such as a gyroscope and an acceleration sensor are enabled to judge a user operation and intention by using a high power consumption algorithm. By taking a motion sensing camera as an example, when the user takes up the intelligent terminal, it is to exit the static mode and the high power consumption algorithm is executed to make a motion sensing judgment at this moment; and when the user takes up the mobile phone and places it at a position which is flush with eyes and keeps the mobile phone static, it is judged that the user expects to photograph, a motion sensing camera function is completed and a camera is enabled to enter an application program.

2. Corresponding relations are established and saved in a corresponding relation list. This link is to combine basic states, user action states and final judgment results. A system has a default corresponding relation at an initial stage, so as to facilitate the user to understand and preliminarily use, and this corresponding relation may be edited by the user. Realization of corresponding relations is also one of core functions of the system, the system detects a basic state and judges whether it enters a user action state to obtain a user action, and then a final judgment result is provided according to the corresponding relation.

In the embodiment of the present disclosure, a friendly user interface and an operation process are established. Here, operations mainly include action recognition introduction, state machine editing, and browsing of optional motion sensing recognition functions.

1. Action introduction includes animation description about supported motion sensing actions.

2. State machine editing is the most important part of interaction with users, and includes two parts, i.e., state editing and corresponding relation editing.

State editing includes addition of new states and editing of existing states. Addition of new states refers to adding mapping conditions for instruction operations, an operation process is similar to power-on guide, one or more conditions may be selected from some optional conditions to decide self-defined states, and the optional conditions include state mode, pocket mode, motion sensing camera, motion sensing dialing and the like, for example. The static mode may be set to be correlated to the motion sensing camera and no motion sensing camera action detection is performed when not exiting the static mode.

3. Browning of optional motion sensing recognition functions is to provide an interface for a user to understand about actions which can be detected by the intelligent terminal under intelligent motion sensing functions.

Through the description of the above-mentioned implementation modes, one skilled in the art may clearly understand that the methods according to the above-mentioned embodiments may be implemented by means of software and a necessary general-purpose hardware platform. Of course, the methods may also be implemented by means of hardware. However, under many situations, the former one is the better implementation mode. Based on such understanding, the solution of the present disclosure substantively or the part which makes a contribution to the prior art may be reflected in the form of a software product, and the computer software product is stored in a storage medium (such as an ROM/RAM, a magnetic disk or a compact disk) and includes multiple instructions used for enabling one terminal device (which may be a mobile phone, a computer, a server or a network device) to execute the method according to each embodiment of the present disclosure.

### Embodiment 2

This embodiment further provides an apparatus for reducing power consumption of a terminal device. The apparatus is used for implementing the above-mentioned embodiment and preferred implementation modes, and thus the content which has already been described is not repetitively described here. As used below, the term “module” may realize a combination of software and/or hardware with predetermined functions. Although the apparatus described in the following embodiments is preferably implemented by means of software, the implementation by means of hardware or the combination of software and hardware is also possible and may be conceived.

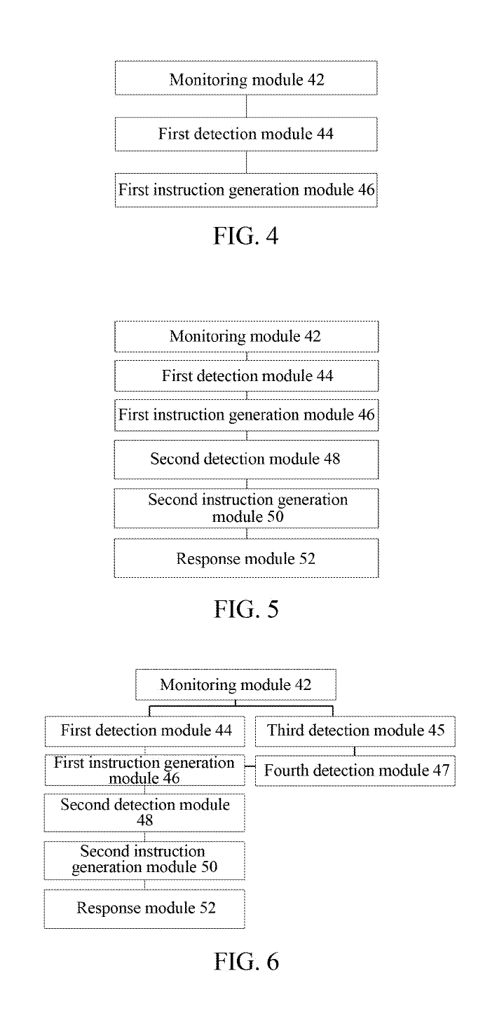

FIG. 4 illustrates a structural diagram of an apparatus for reducing power consumption of a terminal device according to an embodiment of the present disclosure. As illustrated in FIG. 4, the apparatus includes: a monitoring module 42, a first detection module 44 and a first instruction generation module 46.

The monitoring module 42 is configured to monitor a running state of a current terminal device through a first-type sensor.

The first detection module 44 is configured to, when the first-type sensor monitors that there is an operation performed on the terminal device, judge whether a parameter value corresponding to the operation monitored by the first-type sensor is greater than or equal to a first preset threshold value according to a first preset detection condition.

The first instruction generation module 46 is configured to, when the parameter value is greater than or equal to the first preset threshold value, generate a first trigger instruction for triggering a second-type sensor in the terminal to be enabled, herein the power consumption of the first-type sensor is less than the power consumption of the second-type sensor.

In an embodiment of the present disclosure, FIG. 5 illustrates a structural diagram of another apparatus for reducing power consumption of a terminal device according to an embodiment of the present disclosure. As illustrated in FIG. 5, the apparatus further includes: a second detection module 48, a second instruction generation module 50 and a response module 52.

The second detection module 48 is configured to, after the first trigger instruction for triggering the second-type sensor in the terminal to be enabled is generated, enable the second-type sensor according to the first trigger instruction and detect whether a parameter value acquired by the second-type sensor is greater than or equal to a second preset threshold value according to a second preset detection condition.

The second instruction generation module 50 is configured to, when the parameter value is greater than or equal to the second preset threshold value, generate a second trigger instruction for triggering an operation program corresponding to the operation.

The response module 52 is configured to execute the operation program corresponding to the second trigger instruction in response to the second trigger instruction.

In an embodiment of the present disclosure, FIG. 6 illustrates a structural diagram of another apparatus for reducing power consumption of a terminal device according to an embodiment of the present disclosure. As illustrated in FIG. 6, the apparatus further includes: a third detection module 45 and a fourth detection module 47.

The third detection module 45 is configured to, when the parameter value is less than the first preset threshold value, perform detection on the operation for a second time according to the first preset detection condition and judge whether the parameter value corresponding to the operation is greater than or equal to the first preset threshold value.

The fourth detection module 47 is configured to, when the parameter value is less than the first preset threshold value in the detection of the second time according to the first preset detection condition, detect the parameter value corresponding to the operation again according to the first preset detection condition till the parameter value corresponding to the operation is greater than or equal to the first preset threshold value.

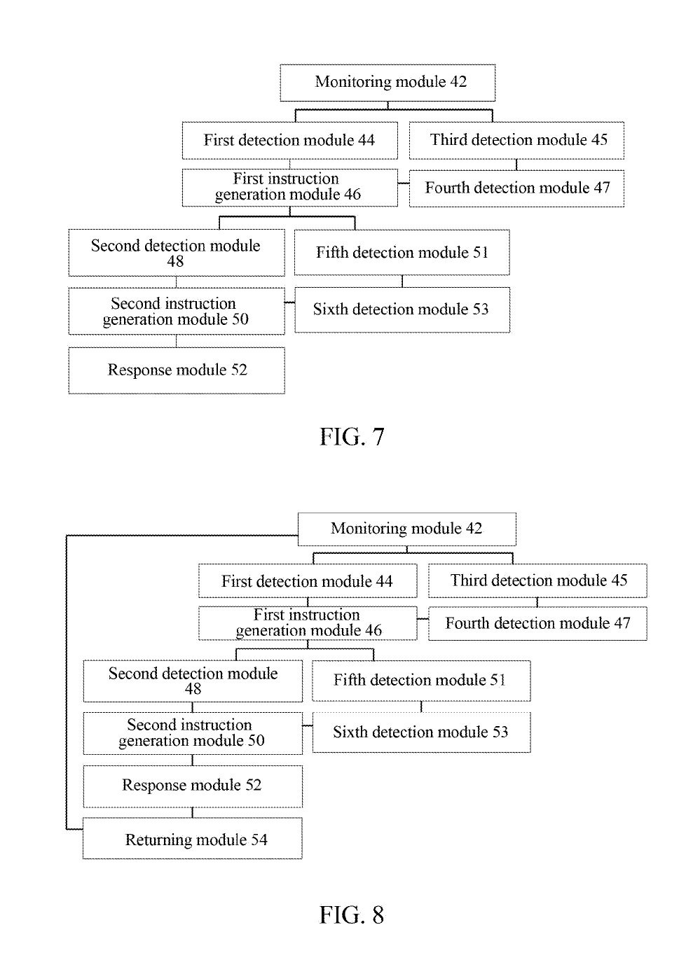

In the embodiment of the present disclosure, FIG. 7 illustrates a structural diagram of another apparatus for reducing power consumption of a terminal device according to an embodiment of the present disclosure. As illustrated in FIG. 7, the apparatus further includes: a fifth detection module 51 and a sixth detection module 53.

The fifth detection module 51 is configured to, when the parameter value is less than the second preset threshold value, perform detection on the operation for a second time according to the second preset detection condition and judge whether the parameter value corresponding to the operation is greater than or equal to the second preset threshold value.

The sixth detection module 53 is configured to, when the parameter value is less than the second preset threshold value in the detection of the second time according to the second preset detection condition, detect the parameter value corresponding to the operation again according to the second preset detection condition till the parameter value corresponding to the operation is greater than or equal to the second preset threshold value.

In an embodiment of the present disclosure, FIG. 8 illustrates a structural diagram of another apparatus for reducing power consumption of a terminal device according to an embodiment of the present disclosure. As illustrated in FIG. 8, the apparatus further includes: a returning module 54.

The returning module is configured to, after the operation program corresponding to the second trigger instruction is executed in response to the second trigger instruction, return an operation state of monitoring the running state of the current terminal device through the first-type sensor.

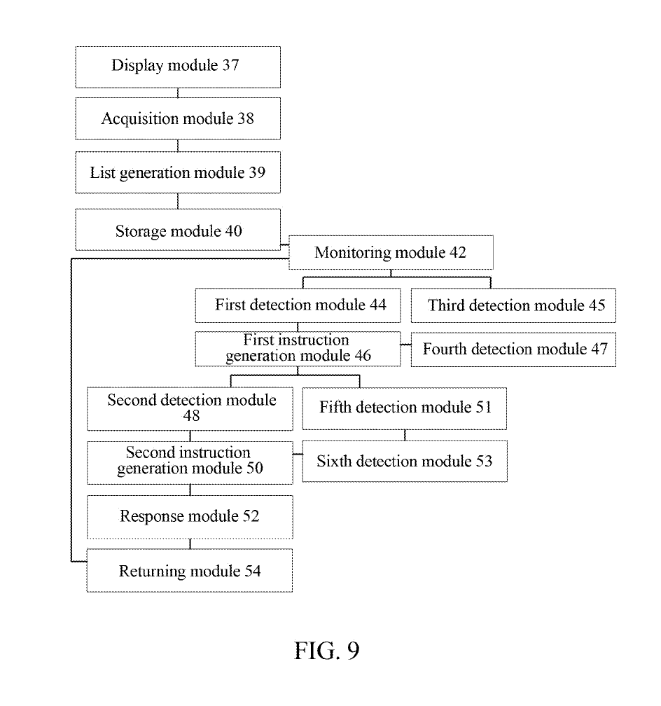

In an embodiment of the present disclosure, FIG. 9 illustrates a structural diagram of an apparatus for reducing power consumption of a terminal device according to another embodiment of the present disclosure. As illustrated in FIG. 9, the apparatus further includes: a display module 37, an acquisition module 38, a list generation module 39 and a storage module 40.

The display module 37 is configured to, before the running state of the current terminal device is monitored through the first-type sensor, display a setting interface.

The acquisition module 38 is configured to acquire a motion sensing parameter edited by a user according to a preset page guide on the setting interface.

The list generation module 39 is configured to acquire a corresponding relation between the motion sensing parameter and the first preset detection condition and the second preset detection condition, and generate a corresponding relation list.

The storage module 40 is configured to store the corresponding relation list.

It needs to be stated that each of the above-mentioned modules may be implemented by means of software or hardware. The former one may be implemented through but is not limited to the following mode: the above-mentioned modules are all located in the same processor; or the above-mentioned modules are respectively located in multiple processors.

An embodiment of the present disclosure further provides a storage medium. In this embodiment, the above-mentioned storage medium may be configured to store program codes for executing the following steps:

S1: a running state of a current terminal device is monitored through a first-type sensor;

S2: when the first-type sensor monitors that an operation performed on the terminal device exists, whether a parameter value corresponding to the operation monitored by the first-type sensor is greater than or equal to a first preset threshold value is judged according to a first preset detection condition; and

S3: when the parameter value is greater than or equal to the first preset threshold value, a first trigger instruction for triggering a second-type sensor in the terminal to be enabled is generated, herein the power consumption of the first-type sensor is less than the power consumption of the second-type sensor.

The storage medium may further be configured to store program codes for executing the following steps:

S1: when the parameter value is less than the first preset threshold value, detection is performed on the operation for a second time according to the first preset detection condition and it is judged whether the parameter value corresponding to the operation is greater than or equal to the first preset threshold value; and

S2: if the parameter value is less than the first preset threshold value in the detection of the second time according to the first preset detection condition, the parameter value corresponding to the operation is detected again according to the first preset detection condition till the parameter value corresponding to the operation is greater than or equal to the first preset threshold value.

In this embodiment, the above-mentioned storage medium may include but are not limited to various mediums such as USB flash disks, Read-Only Memories (ROMs), Random Access Memories (RAMs), mobile hard disks, magnetic disks or compact disks which can storage program codes.

In this embodiment, the processor may execute the following operations according to the program codes stored in the storage medium: after generating the first trigger instruction for triggering the second-type sensor in the terminal to be enabled, the second-type sensor is enabled according to the first trigger instruction and whether the parameter value acquired by the second-type sensor is greater than or equal to a second preset threshold value is detected according to a second preset detection condition; when the parameter value is greater than or equal to the second preset threshold value, a second trigger instruction for triggering an operation program corresponding to the operation is generated; and the operation program corresponding to the second trigger instruction is executed in response to the second trigger instruction.

In this embodiment, the processor may execute the following operations according to the program codes stored in the storage medium: when the parameter value is less than the second preset threshold value, detection is performed on the operation for a second time according to the second preset detection condition and it is judged whether the parameter value corresponding to the operation is greater than or equal to the second preset threshold value; and if the parameter value is less than the second preset threshold value in the detection of the second time according to the second preset detection condition, the parameter value corresponding to the operation is detected again according to the second preset detection condition till the parameter value corresponding to the operation is greater than or equal to the second preset threshold value.

In this embodiment, the processor may execute the following operations according to the program codes stored in the storage medium: the second preset detection condition is used for detecting whether the operation triggers the corresponding operation program; and/or the second preset threshold value is a threshold value determined according to an upper limit of the power consumption of the second-type sensor.

In this embodiment, the processor may execute the following operations according to the program codes stored in the storage medium: after executing the operation program corresponding to the second trigger instruction in response to the second trigger instruction, and after the operation program is completely executed, an operation state of detecting whether the parameter corresponding to the operation acquired by the first-type sensor in the terminal is greater than or equal to the first preset threshold value according to the first preset detection condition is returned.

In this embodiment, the processor may execute the following operations according to the program codes stored in the storage medium: the first preset detection condition is used for detecting whether the operation triggers the second-type sensor; and/or the first preset threshold value is a threshold value determined according to an upper limit of the power consumption of the first-type sensor.

In this embodiment, the processor may execute the following operations according to the program codes stored in the storage medium: the second preset detection condition is used for detecting whether the operation triggers the corresponding operation program; and/or the second preset threshold value is a threshold value determined according to an upper limit of the power consumption of the second-type sensor.

In this embodiment, the processor may execute the following operations according to the program codes stored in the storage medium: before monitoring the running state of the current terminal device through the first-type sensor, a setting interface is displayed; a motion sensing parameter edited by a user is acquired according to a preset page guide on the setting interface; a corresponding relation between the motion sensing parameter and the first preset detection condition and the second preset detection condition is acquired to generate a corresponding relation list; and the corresponding relation list is stored.

For the specific examples in this embodiment, a reference may be made to the examples described in the above-mentioned embodiments and alternative implementation modes, and this embodiment is not repetitively described here.

Apparently, one skilled in the art should understand that all modules or all steps of the present disclosure may be implemented by using general-purpose computing devices, they may be integrated into a single computing device or distributed on a network consisting of multiple computing devices, optionally they may be implemented by using program codes executable by computing devices, thus they may be stored in memory devices and executed by computing devices, and under certain circumstances, the illustrated or described steps may be executed according to a sequence different from the sequence here, or they may be respectively manufactured into individual integrated circuit modules, or multiple modules or steps thereof may be manufactured into a single integrated circuit module to implement. Therefore, the present disclosure is not limited to any specific combination of hardware and software.

The embodiments described above are just preferred embodiments of the present disclosure and are not used for limiting the present disclosure. For one skilled in the art, the present disclosure may have various modifications and variations. Any modification, equivalent replacement, improvement and the like made within the essence and rule of the present disclosure shall be still included in the protection scope of the present disclosure.

### INDUSTRIAL APPLICABILITY

The solution provided by embodiments of the present disclosure can be used for reducing the power consumption of the terminal. A running state of a current terminal device is monitored through a first-type sensor; when the first-type sensor monitors that an operation performed on the terminal device exists, it is judged whether a parameter value corresponding to the operation monitored by the first-type sensor is greater than or equal to a first preset threshold value according to a first preset detection condition. When the parameter value is greater than or equal to the first preset threshold value, a first trigger instruction for triggering a second-type sensor in the terminal to be enabled is generated, herein the power consumption of the first-type sensor is less than the power consumption of the second-type sensor. The problem that power endurance time of the terminal device is reduced due to system power consumption increase caused by the cooperative working of multiple sensors in the related art, is solved, thus gradually enabling sensors with different types of power consumption according to the actual operation, reducing the system power consumption of the terminal device and improving the power endurance time of the terminal device.

What is claimed is:

1. A method for reducing power consumption of a terminal device, comprising:
monitoring a running state of a current terminal device through a first-type sensor;
when the first-type sensor monitors that there is an operation performed on the terminal device, judging whether a parameter value corresponding to the operation monitored by the first-type sensor is greater than or equal to a first preset threshold value based on a first preset detection condition; and
when the parameter value is greater than or equal to the first preset threshold value, generating a first trigger instruction for triggering a second-type sensor in the terminal to be enabled, wherein power consumption of the first-type sensor is less than power consumption of the second-type sensor.

2. The method according to claim 1, wherein, after generating a first trigger instruction for triggering a second-type sensor in the terminal to be enabled, the method further comprises:
enabling the second-type sensor based on the first trigger instruction and detecting whether a parameter value acquired by the second-type sensor is greater than or equal to a second preset threshold value based on a second preset detection condition;
when the parameter value is greater than or equal to the second preset threshold value, generating a second trigger instruction for triggering an operation program corresponding to the operation; and
executing the operation program corresponding to the second trigger instruction in response to the second trigger instruction.

3. The method according to claim 2, wherein the method further comprises:
when the parameter value is less than the first preset threshold value, performing detection on the operation for a second time based on the first preset detection condition and judging whether the parameter value corresponding to the operation is greater than or equal to the first preset threshold value; and
when the parameter value is less than the first preset threshold value in the detection of the second time based on the first preset detection condition, detecting the parameter value corresponding to the operation again based on the first preset detection condition till the parameter value corresponding to the operation is greater than or equal to the first preset threshold value.

4. The method according to claim 2, wherein the method further comprises:
when the parameter value is less than the second preset threshold value, performing detection on the operation for a second time based on the second preset detection condition and judging whether the parameter value corresponding to the operation is greater than or equal to the second preset threshold value; and
when the parameter value is less than the second preset threshold value in the detection of the second time based on the second preset detection condition, detecting the parameter value corresponding to the operation again based on the second preset detection condition till the parameter value corresponding to the operation is greater than or equal to the second preset threshold value.

5. The method according to claim 2, wherein, after executing the operation program corresponding to the second trigger instruction in response to the second trigger instruction, the method further comprises:
returning an operation state of monitoring the running state of the current terminal device through the first-type sensor.

6. The method according to claim 1, wherein the first preset detection condition is used for detecting whether the operation triggers the second-type sensor; and/or the first preset threshold value is a threshold value determined based on an upper limit of the power consumption of the first-type sensor.

7. The method according to claim 2, wherein the second preset detection condition is used for detecting whether the operation triggers the corresponding operation program; and/or the second preset threshold value is a threshold value determined based on an upper limit of the power consumption of the second-type sensor.

8. The method according to claim 1, wherein, before monitoring the running state of the current terminal device through the first-type sensor, the method further comprises:
displaying a setting interface;
acquiring a motion sensing parameter edited by a user based on a preset page guide on the setting interface;
acquiring a corresponding relation between the motion sensing parameter and the first preset detection condition and the second preset detection condition, and generating a corresponding relation list; and
storing the corresponding relation list.

9. An apparatus for reducing power consumption of a terminal device, comprising:
a monitoring module configured to monitor a running state of a current terminal device through a first-type sensor;
a first detection module configured to, when the first-type sensor monitors that there is an operation performed on the terminal device, judge whether a parameter value corresponding to the operation monitored by the first-type sensor is greater than or equal to a first preset threshold value based on a first preset detection condition; and
a first instruction generation module configured to, when the parameter value is greater than or equal to the first preset threshold value, generate a first trigger instruction for triggering a second-type sensor in the terminal to be enabled, wherein power consumption of the first-type sensor is less than power consumption of the second-type sensor.

10. The apparatus according to claim 9, wherein the apparatus further comprises:
a second detection module configured to, after the first trigger instruction for triggering the second-type sensor in the terminal to be enabled is generated, enable the second-type sensor based on the first trigger instruction and detect whether a parameter value acquired by the second-type sensor is greater than or equal to a second preset threshold value based on a second preset detection condition;
a second instruction generation module configured to, when the parameter value is greater than or equal to the second preset threshold value, generate a second trigger instruction for triggering an operation program corresponding to the operation; and
a response module configured to execute the operation program corresponding to the second trigger instruction in response to the second trigger instruction.

11. The apparatus according to claim 10, wherein the apparatus further comprises:
a third detection module configured to, when the parameter value is less than the first preset threshold value, perform detection on the operation for a second time based on the first preset detection condition and judge whether the parameter value corresponding to the operation is greater than or equal to the first preset threshold value; and
a fourth detection module configured to, when the parameter value is less than the first preset threshold value in the detection of the second time based on the first preset detection condition, detect the parameter value corresponding to the operation again based on the first preset detection condition till the parameter value corresponding to the operation is greater than or equal to the first preset threshold value.

12. The apparatus according to claim 10, wherein the apparatus further comprises:
a fifth detection module configured to, when the parameter value is less than the second preset threshold value, perform detection on the operation for a second time based on the second preset detection condition and judge whether the parameter value corresponding to the operation is greater than or equal to the second preset threshold value; and
a sixth detection module configured to, when the parameter value is less than the second preset threshold value in the detection of the second time based on the second preset detection condition, detect the parameter value corresponding to the operation again based on the second preset detection condition till the parameter value corresponding to the operation is greater than or equal to the second preset threshold value.

13. The apparatus according to claim 10, wherein the apparatus further comprises:
a returning module configured to, after the operation program corresponding to the second trigger instruction is executed in response to the second trigger instruction, return an operation state of monitoring the running state of the current terminal device through the first-type sensor.

14. The apparatus according to claim 9, wherein the apparatus further comprises:
a display module configured to, before the running state of the current terminal device is monitored through the first-type sensor, display a setting interface;
an acquisition module configured to acquire a motion sensing parameter edited by a user based on a preset page guide on the setting interface;
a list generation module configured to acquire a corresponding relation between the motion sensing parameter and the first preset detection condition and the second preset detection condition, and generate a corresponding relation list; and
a storage module configured to store the corresponding relation list.
